(19) United States
(12) Patent Application Publication
(10) Pub. No.: US 2016/0168779 A1
(43) Pub. Date: Jun. 16, 2016

(54) LASER-MARKED FABRIC

(71) Applicant: Apple Inc., Cupertino, CA (US)

(72) Inventors: Peter N. Russell-Clarke, Cupertino, CA (US); Michael S. Nashner, Cupertino, CA (US); Robert S. Murphy, Sunnyvale, CA (US)

(21) Appl. No.: 14/933,355

(22) Filed: Nov. 5, 2015

Related U.S. Application Data
(60) Provisional application No. 62/092,039, filed on Dec. 15, 2014.

(51) Int. Cl. D06L 3/04; H01H 11/00; H01H 13/70; D06M 10/00; D06B 11/00

(52) U.S. Cl. CPC D06L 3/04; D06M 10/005; D06B 11/0096; H01H 13/70; H01H 11/00; H01H 2229/02; H01H 2209/068

(57) ABSTRACT

Systems and techniques for laser-marking a fabric material. Some implementations may be directed to a fabric component having a surface dyed a first color using a pigment. The surface may be irradiated using a laser to form a lightened region. In some cases, the lightened region has a second color that is lighter than the first color. In some cases, the lightened region has fibers of the nylon fabric component that are fused to form a partially specular surface due to the laser irradiation. In some cases, the lightened region has fibers of the fabric component that are fused to form a partially specular surface. The fabric material may form a fabric component of a device or product. In some cases, the fabric forms a component of a keyboard or user-input device.

### CROSS-REFERENCE TO RELATED APPLICATION

This application is a non-provisional patent application of and claims the benefit to U.S. Provisional Patent Application No. 62/092,039, filed Dec. 15, 2014, and titled “Laser-Marked Fabric,” the disclosure of which is hereby incorporated herein by reference in its entirety.

### FIELD

This application generally relates to laser-marking a fabric and, in particular, to forming lightened regions on a colored fabric using a laser.

### BACKGROUND

Traditionally, textile printing or marking includes a process for applying color to a textile material or textile component. Traditionally, textile materials may be printed, patterned or marked by subjecting the material to a separate coloring component, such as an ink or dye. For example, traditional dying techniques may include applying a dye or coloring solution to the surface of the textile and/or the individual fibers of the textile. Textiles may also be printed by applying an ink to the surface of the textile using a rolling, screen printing, sputtering or other ink deposition technique.

However, there are some drawbacks associated with some traditional textile marking techniques. In particular, using some traditional dying techniques it may be difficult to create fine features require for small text or lettering. While some ink printing techniques may be used to create fine features, a separate ink material that is deposited or attached to the surface of a textile may be subject to wear and degradation over time. In particular, it may be difficult to maintain an ink-printed pattern on a textile product that is subject to repeated handling or use. Additionally, an application of ink on the surface of the textile may create a raised area or bump, which may be undesirable in some cases.

Thus, there is a need for systems and techniques for marking textile or cloth-based components without some of the drawbacks of traditional techniques.

### SUMMARY

Embodiments described herein are directed to systems and techniques for laser-marking a fabric material. In particular, embodiments include methods for forming a lightened or substantially white region on the surface of a fabric using a laser. The embodiments described herein may be used to laser mark a wide range of fabrics or fabric based components. In particular, the laser-marking techniques of the present discloser may be used to create text, graphical elements, or other patterns on the surface of a product having at least a portion of a surface formed from a fabric material. Example products include, without limitation, wearable products, straps, lanyards, covers, enclosures, keyboards, user-input devices, and so on.

In some embodiments, a fabric material is laser marked to form a lightened region within surface of the fabric material. At least a portion of the fabric material may be a dyed a first color using a pigment or coloring solution. The surface may be irradiated using a laser to form a lightened region. In some cases, the lightened region has a second color that is lighter than the first color. In some cases, the lightened region has a substantially reduced concentration of pigment caused by the laser irradiation. In some implementations, irradiating the surface using the laser causes evaporation of at least part of the color pigment. In some cases, irradiating the surface using the laser causes evaporation of substantially all of the color pigment within the irradiated region. Thus, in some cases, the laser irradiation results in a substantially reduced concentration in pigment in the irradiated portion of the fabric material.

In some embodiments, irradiating the surface using the laser causes an increase in a surface concentration of TiO2 with respect a non-irradiated region of the surface. In some instances, the increase in surface concentration of TiO2 is less than 100 nanometers from the surface of a fiber of the fabric component. The fabric component may be formed from a nylon fabric material having a TiO₂ additive. Similarly, in some cases, irradiating the surface using the laser causes an increase in a surface concentration of CaCO₃ with respect a non-irradiated region of the surface. The amount of TiO₂ or CaCO₃ that is included as an additive in the fiber material may be varied to produce the desired laser-marking results. In some cases, the amount of TiO₂ or CaCO₃ is increased to produce a lighter or whiter laser-marked region.

In some embodiments, irradiating the surface includes producing a series of pulses of ultraviolet light incident on the surface of the colored area. In some embodiments, irradiating the surface using the laser causes fibers of the fabric component to fuse to form a partially specular surface. In some cases, the fibers of the fabric component are not substantially ablated or removed by the laser irradiation. In some cases, the irradiated fibers are substantially free of brown discoloration or charring due to the laser irradiation.

Some example embodiments are directed to a fabric component including a colored region dyed a first color using a pigment. The fabric component may also include a lightened region formed by irradiating the colored region using a laser. In some cases, the lightened region has a second color that is lighter than the first color due to the laser irradiation. In some cases, the lightened region has a concentration of pigment that is substantially reduced due to the laser irradiation. In some cases, the lightened region has fibers of the nylon fabric component that are fused, or at least partially fused, to form a partially specular surface due to the laser irradiation.

In some embodiments, the fabric is formed from a nylon material having one or more chemical additives, including, for example, TiO₂ and/or CaCO₃ additive compounds. In some embodiments, the lightened region of the fabric has an increased surface concentration of TiO₂ caused by the laser irradiation. In some embodiments, the lightened region of the fabric has an increased surface concentration of CaCO₃ caused by the laser irradiation. In some embodiments, the lightened region is substantially white due, in part, to the increased surface concentrations of TiO₂ and/or CaCO₃.

Some example embodiments are directed to a method for forming a glyph on a key of a fabric keyboard. A fabric membrane for forming the upper exterior surface of the fabric keyboard may be provided. The fabric membrane may include an embossed key region having a dyed color. The embossed key region may be positioned relative to a laser. The embossed key region may be irradiated using the laser to form the glyph associated with the key of the keyboard. The irradiated region formed by the laser may have a color that is lighter than the dyed color of the embossed key region.

In some embodiments, forming the glyph using the laser includes increasing a surface concentration of TiO₂ for a laser-irradiated portion of the fabric membrane with respect to a non-irradiated portion of the fabric membrane. In some embodiments, forming the glyph using the laser includes increasing a surface concentration of CaCO₃ for a laser-irradiated portion of the fabric membrane with respect to a non-irradiated portion of the fabric membrane. In some embodiments, the dyed color includes a pigment and forming the glyph using the laser includes reducing the amount of pigment for a laser-irradiated portion of the fabric membrane with respect to a non-irradiated portion of the fabric membrane. In some embodiments, forming the glyph using the laser includes at least partially fusing the fibers of the fabric membrane to create a partially specular surface.

In some embodiments, the fabric membrane is installed or assembled into a keyboard assembly. The installation may include, for example, bonding a lower surface of the embossed key region to a keycap of the fabric keyboard; and bonding a non-embossed region to a frame of the fabric keyboard. In some cases, other elements or components are bonded or attached to the fabric membrane during the installation process.

In some cases, the glyph is formed as a positive image, For example, the laser may irradiate a region associated with the glyph to form a lightened glyph surrounded by a colored region. In some cases, the colored region is grey and the lightened glyph is substantially white. In some cases, the glyph is formed as a negative image. For example, the laser may irradiate a region surrounding the glyph to form a lightened region surrounding by a colored glyph.

Some example embodiments are directed to a fabric keyboard including a set of keycaps configured to actuate a corresponding set of key switches. The keyboard may also include a fabric component disposed over the set of keycaps. In some embodiments, the fabric component includes a colored region and at least one glyph that has been formed in the colored region using laser irradiation process. In some cases, the laser irradiation process lightens at least a portion of the colored region.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example laser-marked fabric-based product.

FIG. 2 depicts an example fabric-based component and an electronic device.

FIG. 3 depicts a detail view of an example laser-marked fabric-based component.

FIG. 4 depicts a cross-sectional view of an example key of a fabric keyboard.

FIG. 5 depicts an example laser-marking system.

FIG. 6 depicts an example laser-marking process.

FIG. 7 depicts an example laser-marking process for a fabric keyboard.

### DETAILED DESCRIPTION

Textiles and fabrics may be used to form various components of a device or product. In general, fabric may provide a desirable texture, flexible form factor, and durability for use in certain products. For example, fabric or fabric-based components may be particularly suitable for use for device exteriors, device covers, protective housings, bags, cases, and other housings or covers. As described in more detail below, fabric-based components may also be used to form part of a user-input device, including, for example a keyboard, keypad, and the like. Textiles and fabrics may also be used in wearable components and attachment systems, including for example, bands, lanyards, straps, and the like.

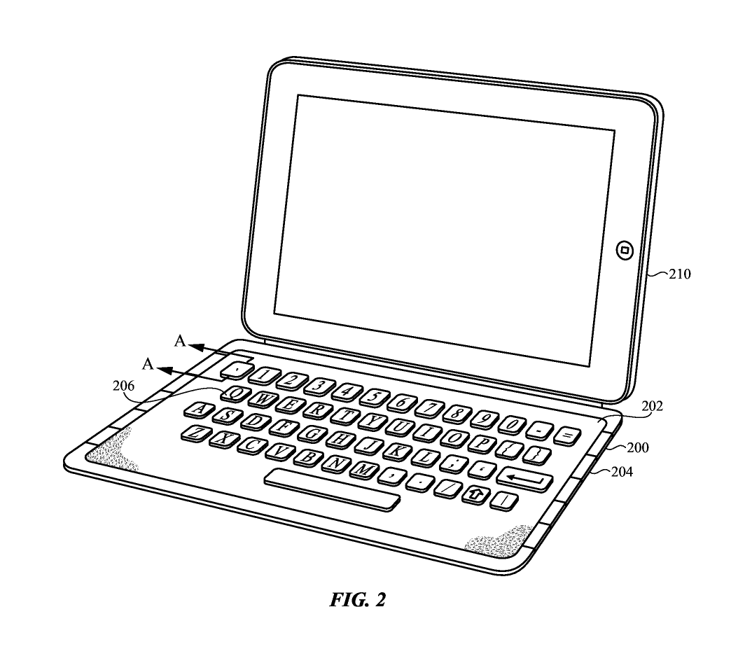

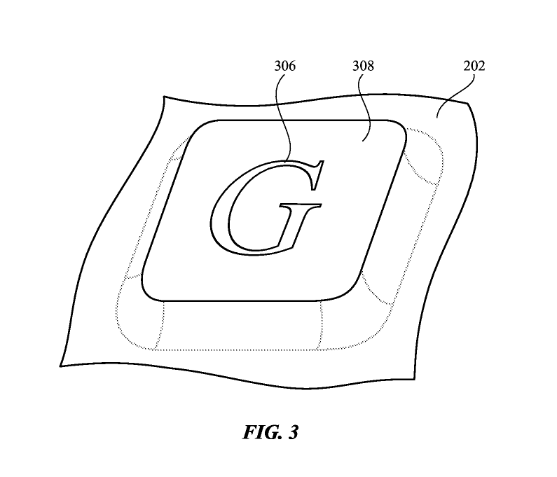

In general, the techniques and systems described herein may be applied to a wide range of fabric components or fabric-based products. More specifically, the embodiments described herein may be relevant to forming a pattern or graphical region on the surface of a fabric component or element. In some embodiments, a laser is used to create a lightened region on the surface of a fabric. The lightened region may contrast with the color of the surrounding fabric to form a defined pattern or graphical symbol. As described in more detail below with respect to FIGS. 2 and 3, a laser based coloring operation may be used to form the glyphs or symbols for a keyboard or touch pad.

In some embodiments, a pulse of laser light is used to irradiate a portion of the surface of a fabric to cause a physical change in the fibers of the fabric. For example, a series of laser pulses may be used to fuse or at least partially fuse the fibers of the fabric together and alter the surface properties of the fabric over the irradiated region of the fabric. In some cases, the partially fused fabric causes the light to reflect differently off the irradiated region as compared to the surrounding fabric, which may increase the contrast between the two regions. In some cases, the partially fused fabric results in a lightened color as compared to the surrounding fabric.

In some embodiments, a pulse of laser light is used to irradiate a portion of the surface of the fabric to cause a chemical change in the fibers of the fabric. In some instances, laser irradiation may be used to partially evaporate dye or color components of the fabric material. Evaporating the dye elements of a fabric may result in a lighted color over the irradiated region and enhance the contrast with respect to the surrounding fabric.

In some embodiments, a pulse of laser light is used to irradiate a portion of the surface of the fabric to cause a chemical change near the surface of the fibers of the fabric. In some instances, laser irradiation may be used to create an increased concentration of certain chemical compounds at or near the surface of the fibers, which may lighten the color of the irradiated portion as compared to the surrounding fabric. In some instances, titanium oxides such as TiO₃ may be formed or migrate to the surface of the fibers of the fabric when irradiated with a pulse of laser energy. Similarly, calcium carbonate CaCO₃ may be formed or migrated to the surface by a pulse or series of pulses of laser energy. By forming and/or migrating certain chemical compounds to the surface of the fabric, the color of the irradiated region may be lighted as compared to the surrounding fabric.

Depending on the intensity and duration of the laser pulse irradiation, various levels of lightening may be achieved on certain types of fabric material. In particular, nylon-based fabric, polyether fabric, and other polymer-based fabric compositions may be particularly well suited for laser marking operations and techniques described herein. In some embodiments, the lighting effects discussed above, either alone or in various combinations, may be used on a polymer-based fabric to create a lightened region or area on the surface of the fabric. In some examples described in more detail below, a laser may be used to form a lightened region that visually contrasts with the surrounding fabric to form a pattern or graphical symbol.

In some cases, it is generally undesirable that the irradiation ablate or remove fibers of the fabric during the laser irradiation process. Ablation or significant destruction of the fiber structure may compromise the mechanical integrity of the fabric, which may be undesirable for some applications. Furthermore, in some cases, it may be generally undesirable that the laser irradiation cause a charring or darkening of the laser-treated region. A burned, charred, or darkened region may reduce the lightening effects or results described above

Many electronic devices utilize one or more input devices to receive input from one or more users. Such input devices include, but are not limited to, one or more keyboards, keypads, buttons, and so on. In some cases, such input devices may also provide output to one or more users that may or may not be associated with received inputs.

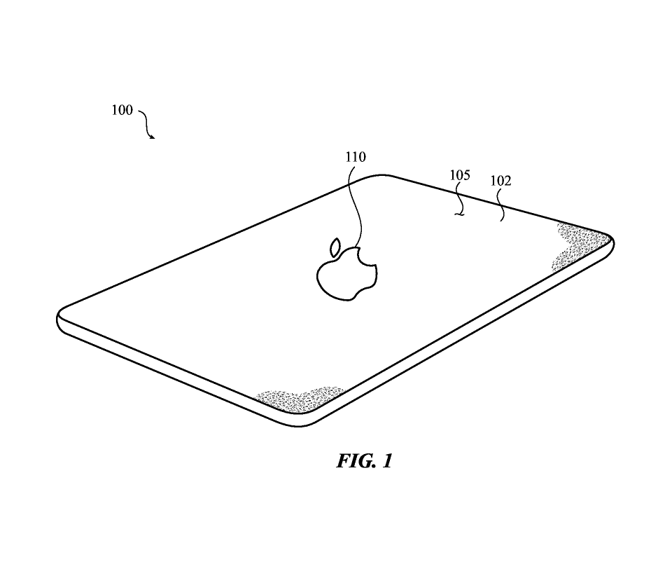

In some embodiments, a laser may be used to mark the surface of a fabric-based component or product. FIG. 1 depicts an example laser-marked textile component. In particular, FIG. 1 depicts a product 100 that may be used as a protective cover or case for a portable electronic device. The product 100 may include a solid core that provides structural rigidity and mechanical strength for the protective cover. The solid core may also provide the shape of the product 100 and facilitate attachment to an electronic device.

As shown in FIG. 1, the product 100 includes a fabric component 102 having an outer surface 105. In the present example, the fabric component 102 may include a polymer-based fabric material, such as a polyimide or nylon-based fabric material. In the present embodiment, the fabric component 102 includes a dye or colored component used to color the fibers of the fabric. The dye or colored component may be applied to the fabric component 102, the threads, and/or to the fibers that form the fabric component 102. The dye may include a variety of dye compositions, including, for example, natural dyes, acid dyes, disperse dyes, reactive dyes, and others.

In the present embodiment, the fabric component 102 substantially covers the exterior surface of the product 100 forming a durable protective coating and cosmetic finish for the product 100. While the fabric component 102 is depicted as being formed from a single continuous sheet, in some embodiments, the fabric component 102 may combined with other components or materials to form the exterior surface of the product 100.

As shown in FIG. 1, a graphical symbol 110 is formed in the surface 105 of the fabric component 102. In this example, the graphical symbol 110 is a company logo that identifies the manufacturer of the product 100. In other embodiments, additional graphics and/or text may also be formed into the surface 105 of the fabric component 102. In the present example, the graphical symbol 110 may be formed using a laser irradiation operation to create a lightened region of the fabric component 102 as compared to non-irradiated regions of the surface 105. In particular, the graphical symbol 110 may be formed by using a series of laser pulses to alter the physical and/or chemical composition of the irradiated fabric. In some embodiments, laser irradiation evaporates a portion of the fabric dye to create the lighted region. In some cases, the laser irradiation causes a migration or one or more chemical compounds, which may also create the lightened region. In some cases, the laser irradiation may also fuse or partially fuse the fibers of the fabric within the irradiated region, which may also alter the light-reflective properties of the fabric and increase the contrast with respect to non-irradiated regions.

In some embodiments, the resolution of the graphical symbol 110 or any other marking, such as text, may be determined by the spot size of the laser and also the size and density of the fibers or threads used to form the fabric. In some embodiments the fabric membrane of the keyboard is formed from a polyimide or nylon material having a fiber density ranging from 40 to 70 denier. In some embodiments, the fabric membrane of the keyboard is formed from a polyester material having a fiber density ranging from 40 to 70 denier

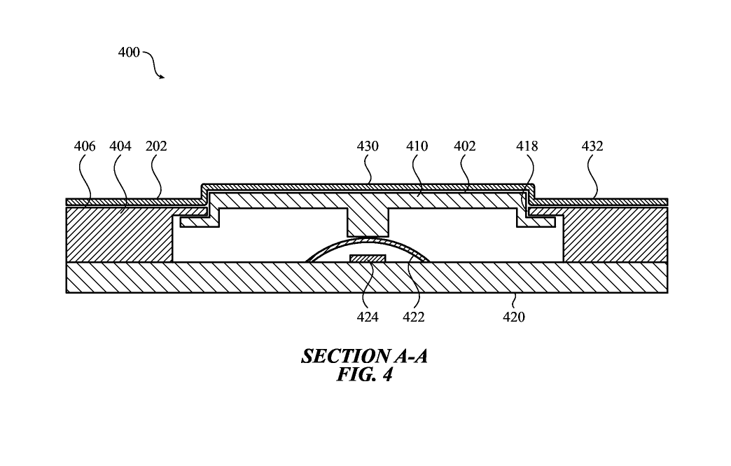

Similar techniques may be used to form graphical symbols, patterns, or text on a variety of different types of products. FIG. 2 depicts another example textile product, specifically a fabric keyboard 200 attached and operatively coupled to an electronic device 210. In this example, the keyboard 200 is formed as part of a cover 204 that is attached to the electronic device 210 and may be used to protect the display screen of the device 210 when not in use. The cover 204 also includes electrical interconnects between the keyboard 200 and the electrical device 210. As shown in FIG. 2, the fabric keyboard 200 includes a fabric membrane 202 that forms the upper exterior surface of the fabric keyboard 200 and is attached to other structural elements of the keyboard. In the present embodiment, the keyboard includes a set of keycaps configured to actuate a corresponding set of key switches. The fabric membrane 202 is disposed or positioned over the set of keycaps. A more detailed description of the keycaps and key switches is provided below with respect to FIG. 4.

As shown in FIG. 2, a set of graphical symbols or keyboard glyphs 206 are formed into the surface of the fabric membrane 202. The set of glyphs 206 correspond to alpha-numeric symbols associated with each key of the set of keys. In some embodiments, the set of glyphs 206 correspond to the symbols of a standard QWERTY keyboard layout. It may be generally desirable that the glyphs 206 formed on a fabric membrane 202 be able to withstand repeated contact and impact associated with the operation of a keyboard. In some cases, some traditional ink-based marking operations may not provide adequate durability to endure repeated contact associated with normal keyboard use. In some instances, a laser-based marking technique may provide certain advantages over some traditional ink-based marking techniques. In particular, a laser may be used to alter the physical and/or chemical properties of the fabric membrane 202 to form lightened regions. The lightened regions may contrast with the color of the fabric membrane 202 to define the set of glyphs 206.

FIG. 3 depicts a detail view of an example laser-marked textile component. More specifically, FIG. 3 depicts a single glyph 306 formed on a key region 308 of the fabric membrane 202. In some embodiments, the fabric membrane 202 includes a dye or colored component used to color the fibers of the fabric. The dye or colored component may be applied to the fabric, the threads, and/or to the fibers that form the fabric membrane 202. As discussed previously, the dye may include a variety of dye compositions, including, for example, natural dyes, acid dyes, disperse dyes, reactive dyes, and others. The dye may create a dark or colored area over at least a portion of the fabric membrane 202.

In the present example, the glyph 306 is formed using a laser-marking process that is used to lighten a region of the fabric membrane 202 which may contrast with the dark or colored fabric membrane 202. In some embodiments, a series of laser pulses may be used to evaporate the dye of the fabric membrane 202 to help create a lighted region on irradiated portion of the fabric membrane 202. In some embodiments, a series of laser pulses may be used to alter the chemical composition of the surface of the fabric membrane 202 to help create a lighted region. In particular, laser irradiation may cause the creation and/or migration of titanium compounds in the fabric component. In one example, if the fabric membrane 202 includes a polyimide material having a titanium additive, laser irradiation may cause the migration of titanium to the surface of the material and form an increased concentration of titanium oxide (TiO₂) on or near the surface of the fibers of the fabric. In general, the titanium oxide may have a white or whitish color that lightens the appearance of the irradiated region. Similarly, laser irradiation may be used to cause the formation and/or migration of other chemical compounds, such as CaCO₃, which may also have a white or whitish color that lightens the irradiated region. In some embodiments, the laser irradiation also fuses or partially fuses the fibers of the fabric membrane 202, which may alter the light-reflecting properties of the irradiated region. In some cases, the fusing of the fibers creates a surface that is more specular and/or reflects a lighter color thereby increasing the contrast between the irradiated region and the surrounding fabric.

The color and light-reflective changes caused by laser irradiation may be used to form the glyph 306 depicted in FIG. 3. In some embodiments, the region of the glyph 306 is lightened using a laser-based operation to create a light or white glyph 306 that contrasts with a dark or colored key region 308. This may also be referred to as a positive glyph or marking technique. In an alternative embodiment, a substantial portion of the key region 308 is lightened using a laser-based operation leaving a dark or colored glyph 308. This may also be referred to as a negative glyph or marking technique.

Forming the glyph 306 may provide several advantages over some ink-based marking techniques. For example, because the glyph 306 is produced by changing the chemical and physical properties of the fabric, the glyph 306 is less prone to wear or degradation caused by repeated contact associated with normal keyboard operation. Additionally, because no material is added to form the glyph 306, the entire key region 308 may be substantially uniform in height and texture, which may be particularly desirable for a keyboard key surface. In some embodiments, the laser irradiation does not significantly alter or impair the mechanical strength of the irradiated fabric, which may minimize the impact of laser marking on the durability of the fabric membrane 202.

The key region 308 is generally coupled to a keycap that is used to actuate a key switch. FIG. 4 is a cross sectional view of a key 400 of the fabric keyboard 200 of FIG. 2 taken along line A-A of FIG. 2. As illustrated, the fabric membrane 202 may be bonded (such as by adhesive 402) to the top surface of a keycap 205 and to a frame 404 (such as by adhesive 406). The frame 404 includes an aperture 418 in which a keycap 410 is operable to move. Vertical movement of the keycap 410 may activate a key switch by deforming a dome 422 to connect with a contact 424. The dome 422 and contact 424 may be positioned on a substrate 420, which may be formed from a printed circuit board (PCB). The dome 422 may be held in place on the substrate 420 by an adhesive film, membrane or other retaining technique.

In some embodiments, the fabric membrane 202 may be embossed to include one or more embossed regions (or embossed structures) 430 and one or more un-embossed regions 432. At least a part of the embossed region 430 may be bonded to the keycap 410 and the un-embossed region 432 may be bonded to the frame 404. As further illustrated, the embossed region 430 may include a top section and side sections that are generally perpendicular to the top section. The at least a portion of the top section may be bonded to at least a portion of the top surface of the keycap 410 and the side sections may be unbonded such that the side sections are able to buckle and/or bend during vertical movement of the keycap 410. In some cases, the bonded area is less than the total area of either the top of the keycap or the top section of the embossed region 430. This may facilitate unrestricted movement of the side sections and prevent the fabric from being in substantial tension during vertical movement of the keycap.

In general, the height of the side sections may be related to the distance that the keycap travels to activate the switch. The embossed region 230 may be embossed at height such that the side sections are able to buckle and/or bend during travel of the keycap 410 and the fabric does not need to stretch to provide for normal movement of the keycap 410. In general, the height of the side sections may be configured to accommodate keycaps with a corresponding vertical travel distances. The embossed region 230 may be configured to minimize or avoid stress on the key during normal operation. In particular, the side sections may be configured to prevent the fabric from exerting substantial (tensile) force on the keycap or from exerting a force on the key switch.

In the embodiment depicted in FIG. 4, the fabric membrane 202 may cover the aperture 418. In some cases, the fabric membrane 202 may also dampen sound from operation of the key, such as noise produced during movement of the keycap 410. In some embodiments, the fabric membrane 202 may also form a barrier that may restrict passage of contaminants into the aperture 148, such as dust, food, or other particles and/or water and/or other liquids. This may help protect components such as the dome 422 or the contact 424 from corrosion and/or other damage and/or prevent such contaminants from otherwise interfering with operation of the key.

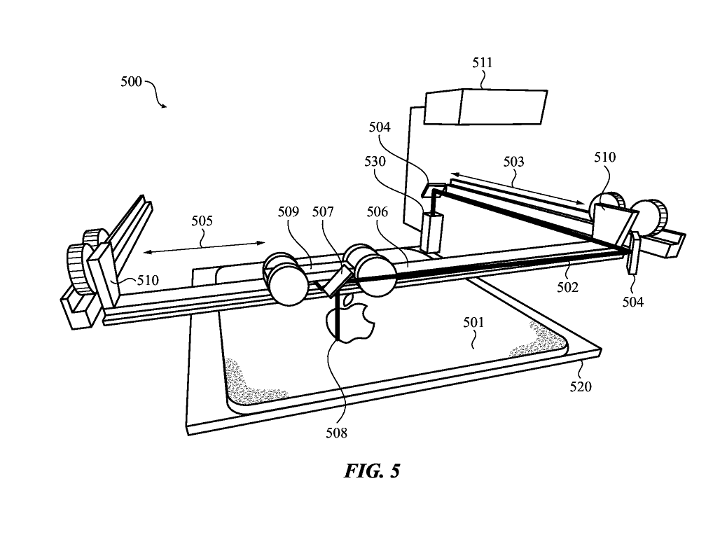

FIG. 5 depicts an example laser system 500 that may be used to perform the laser irradiation or laser marking described in some embodiments. As shown in FIG. 5, the laser system 500 includes a laser source 530 that is configured to produce a laser beam 502 that is directed through the system 500 using multiple optical elements 504. The laser source 530 may include a neodymium-doped yttrium aluminium garnet (Nd:YAG) laser source, neodymium-doped yttrium orthovanadate (Nd:YVO₄) laser source, excimer laser source, or other laser source that is configured to produce ultraviolet or near-ultraviolet laser light. The optical elements 504 may include mirrored surfaces, lenses, and other beam-directing elements for directing the laser beam 502. In some embodiments, the optical elements 504 may be specially configured to direct ultraviolet or near-ultraviolet laser light. The laser beam 502 is directed to an irradiation point 508, which may be incident to the surface of the product 501. The product may include one of the examples described above, including, for example, a fabric-based case and a fabric keyboard.

In the example depicted in FIG. 5, the product 501 is positioned on a table 520, which may remain stationary during a laser-marking operation. The laser beam 502 may be traversed or positioned with respect to the surface of the product 501 using a two-axis gantry configured to direct the laser beam 502 along a y-axis 503 and an x-axis 505 directions. In this example, a trolley 509 is mounted to an x-beam 506 and is configured to move a beam-steering mirror 507 along the x-axis 505 direction. The x-beam 506 may traverse along the y-axis 503 direction by gantry drive 510. In some embodiments, the beam-steering mirror 507 may rotate to adjust the angle of incidence of the laser beam 502 on the surface of the product 501.

The operation of the laser system 500 may be controlled by controller 511, which may include a processing unit and computer memory for storing non-transitory computer-readable instructions. The computer-readable instructions may include instructions for controlling the operation of the laser source 530. For example, the computer-readable instructions may include instructions for setting the power level, the pulse time, and other operating parameters of the laser source 530. The controller may also be configured to control the operation of the gantry drive 510 and the trolley 509 in order to traverse the laser beam 502 across the surface of the product 501.

In some embodiments, the controller 511 is configured to receive parameters associated with a graphical design or marking to be formed on the surface of the product 501. The parameters associated with the graphical design or marking may be provided by an external computer network and/or storage medium and stored in the non-transitory computer memory of the controller 511. In general, the stored parameters may be used to execute instructions to control the operation of the laser source 530, gantry drive 510, and/or the trolley 509 to provide a coordinated set of operations to create a lightened region or regions on the surface of the product 501.

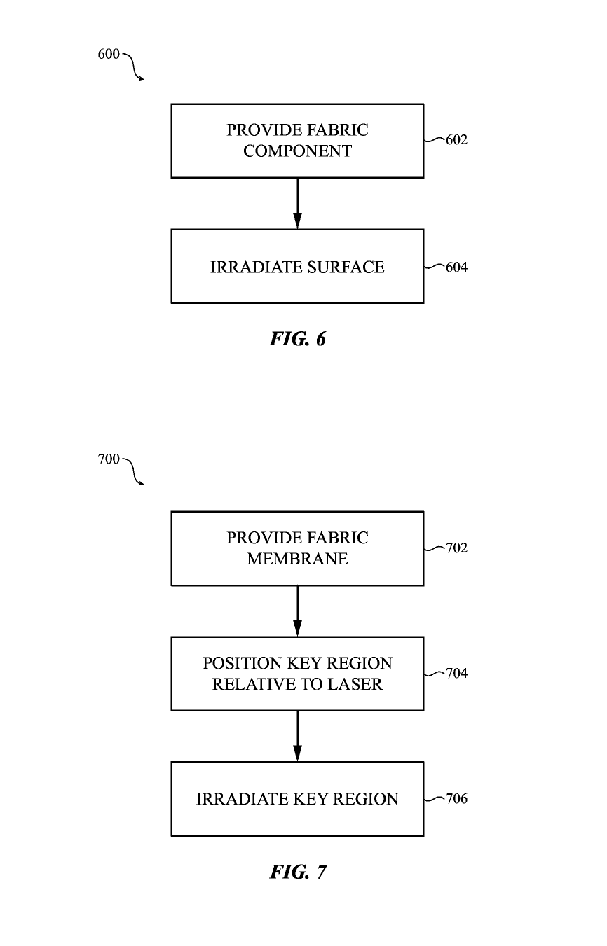

FIG. 6 depicts an example laser-marking process 600. The example marking process 600 may be used to create a lightened region on a fabric or textile component that has been dyed or colored using coloring solution. Example process 600 may be used to form the laser-formed marks depicted in FIGS. 1-3.

In operation 602, a fabric component is provided. In particular, a fabric component having a surface dyed a first color is provided for laser marking. The fabric components may be positioned with respect to a laser device in preparation for the laser irradiation of operation 602. The fabric component may be provided as a separate piece or, alternatively, the fabric component may be provided along with other components of an assembly. In some embodiments, the fabric component is provided as part of a device or product that includes other non-fabric components.

The surface of the fabric component may be dyed using a pigment. Example dyes include, for example, natural dyes, acid dyes, disperse dyes, reactive dyes, and others. The dye may include one or more pigments that produce a first color when the fabric or the fibers of the fabric are dyed. The pigment may include any component or compound that imparts color to the fibers of the fabric. The fabric may be dyed using any one of a number of different techniques. For example, the individual strands or threads of the fabric may be dyed before they are woven or formed into the fabric cloth. In some embodiments, the strands or threads may be coated or subjected to a dye solution after they have been formed. In some embodiments, if the strands or threads are formed from a polymer material, the material used to form the strands may already include a pigment before the strands are formed. In some embodiments, the fabric component is dyed in cloth form. For example, the fabric component may be subjected to an immersion or printing process that introduces the dye to the fabric component.

In some embodiments, the dye may create a dark or colored area over at least a portion of the fabric component. For purposes of process 600, a colored area created by the pigment includes any color that is different than the natural color of the fiber of the fabric. In some embodiments, the entire fabric component is dyed with the pigment. In some embodiments, only a portion or region of the fabric component is dyed. For example, the fabric component may be dyed according to a pattern or a design having the color applied over different regions. The fabric component may also be dyed using a variety of different colors.

In operation 604, the surface of the fabric is irradiated using a laser. In particular, the portion of the surface to be marked is irradiated with a laser to form a lightened region. In some embodiments, the lightened region has a second color that is lighter than the first color. The lightened second color may be due to one or more effects of the laser irradiation. In particular, the laser irradiation may alter the chemical and/or physical composition of the irradiated portion of the fabric.

In operation 604, a portion of the fabric may be irradiated using a series of laser pulses produced by a ultraviolet (UV) laser source. In some embodiments, the energy delivered by the laser pulses is sufficient to cause a lightening of the fabric color but is also carefully controlled to not over-expose or over-irradiate the fabric component, which may cause burning or charring of the fabric material. In some cases, a burning or charring of the fibers may cause an undesirable discoloration. Over exposure may also alter the mechanical structure of the fibers in an undesirable fashion. For example, in some cases, the laser irradiation of operation 604 does not cause significant ablation or otherwise remove the fiber material of the fabric component.

In some embodiments of operation 604, irradiating the surface using the laser causes an increase in a surface concentration of TiO₂ with respect a non-irradiated region of the surface. The increase in concentration of TiO₂ at or near the surface of the fibers may cause a lighting of the fabric within the irradiated region. Because TiO₂ is white in color, the presence of TiO₂ may cause a lighting or whitening of the color of the fabric. In some cases, TiO₂ or other titanium compounds are included as additives to the raw material used to form the fibers of the fabric component. In particular, TiO₂ may be added to a nylon or polyimide raw material used to form a polyimide-based fabric component. The amount of TiO₂ that is added may depend, at least in part, on the amount of color lightening that is desired from the laser irradiation operation. That is, the amount of TiO₂ may be increased in order to increase the lighting produced by the laser irradiation operation.

In some embodiments, the irradiation of the laser may causes the TiO₂ to migrate toward the surface of the fibers of the fabric. In some cases, the overall concentration of TiO₂ is reduced by the laser irradiation, while the surface of the fibers experience an increase in concentration. In some cases, the increase of concentration is less than 100 nanometers below the surface of the fiber material. In some embodiments, the fibers of the fabric have a non-uniform distribution of TiO₂ due to the laser irradiation of operation 604.

In some embodiments of operation 604, irradiating the surface using the laser may cause an increase in a surface concentration of other chemical compounds. For example, irradiating the surface using the laser may cause an increase in a surface concentration of CaCO₃ with respect a non-irradiated region of the surface. In some embodiments, the presence of CaCO₃ may also lighten or whiten the color of the dyed fabric component. In some instances, CaCO₃ may be introduced into the fiber as an additive. The amount of CaCO₃ that is added may depend, at least in part, on the amount of lightening that is desired by the laser irradiation operation 604. Similar to the previous example, the laser irradiation may cause the CaCO₃ to migrate toward the surface of the fabric fibers. In some cases, the overall concentration of CaCO₃ is reduced by the laser irradiation, while the surface of the fibers experience an increase in concentration. In some cases, the increase of concentration is less than 100 nanometers below the surface of the fiber material. In some embodiments, the fibers of the fabric have a non-uniform distribution of CaCO₃ due to the laser irradiation of operation 604.

In some embodiments of operation 604, irradiating the surface using the laser may cause evaporation of at least part of the color pigment. In particular, the energy and heat produced by the laser irradiation may cause the color pigment to evaporate or otherwise dissipate from the fibers of the fabric component. In some embodiments, the laser irradiation may substantially reduce the concentration of pigment within an irradiated portion as compared to a non-irradiated (and dyed) portion of the fabric component. In some embodiments, irradiating the surface using the laser causes evaporation of substantially all of the color pigment within the irradiated region. The removal of some or all of the color pigment may cause a lightening or whitening of the irradiated region.

In some embodiments of operation 604, the laser irradiation may cause the fibers to at least partially fuse together, which may alter the light-reflecting properties of the irradiated portion of the fabric component. In some cases, the irradiated region may have fibers that are at least partially fused to form a partially specular surface. For example, the fibers may be partially melted and fused together to form a surface that is more continuous and/or smooth as compared to a non-irradiated portion of the fabric component.

In general, process 600 may be performed to create a lightened or substantially white pattern on the surface of the fabric component. In accordance with the examples provided above with respect to FIGS. 1-3, the laser marking process 600 may be used to form a graphical symbol, text, and/or keyboard glyph. Additionally or alternatively, the laser marking process 600 may be used to create any type of graphical pattern on the fabric component using the contrast created by the lightening of the laser irradiation.

FIG. 7 depicts a flow chart of an example process 700 for forming a glyph of a fabric keyboard. In some embodiments, process 700 may be used to laser-mark regions, form text, symbols, or other graphical elements on a fabric component of a keyboard or other user-input device. In particular, example process 700 may be used to form the glyph of the keyboard described above with respect to FIGS. 2-4.

In operation 702 a fabric membrane is provided. In some embodiments, the fabric membrane forms the upper exterior surface of the fabric keyboard. In some embodiments, the fabric membrane includes an embossed key region having a dyed color. The dye may include a pigment that may be applied to the fabric, the threads, and/or to the fibers that form the fabric membrane. As discussed previously, the dye may include a variety of dye compositions, including, for example, natural dyes, acid dyes, disperse dyes, reactive dyes, and others. The dye may create a dark or colored area over at least a portion of the fabric membrane.

In operation 704, the embossed key region is positioned relative to a laser. In some embodiments, the fabric membrane having the embossed key region is positioned with respect to a laser device that is configured to produce a laser pulse. For example, the embossed key may be placed on a laser table similar to as described above with respect to FIG. 5. The embossed key and/or the laser may be moved as part of operation 704. For example, in some embodiments, the laser is moved relative to the embossed key region using one or more goniometers or other beam-steering mechanism. Additionally or alternatively, in some embodiments, the embossed key region is moved relative to the laser using, for example, a positioning table or mechanism.

In operation 706, the embossed key region is irradiated using the laser to form the glyph associated with the key of the keyboard. In some embodiments, the glyph is has a color that is lighter than the dyed color of the embossed key region. The lightened color may be due to one or more effects of the laser irradiation. In particular, the laser irradiation may alter the chemical and/or physical composition of the irradiated portion of the fabric. Similar to the examples described above with respect to process 600, the laser irradiation may cause a migration of TiO₂, CaCO₃, or other chemical compound to the surface of the fabric fibers. The migration of certain chemical compounds due to the laser irradiation may form the lightened area that defines the glyph. In some embodiments, an additive including TiO₂, CaCO₃, or other chemical compound may be added to the raw material used to form the fibers of the fabric to enhance the lightening effect due to laser irradiation. Additionally or alternatively, in some embodiments the laser irradiation causes a partial or complete evaporation of the pigment of the dye to form the lightened area of the glyph. In some embodiments, the laser irradiation also causes a partial fusing of the fibers within the irradiated region, which may alter the light-reflective properties of the irradiated region.

In operation 706, a portion of the fabric may be irradiated using a series of laser pulses produced by a ultraviolet (UV) laser source. In some embodiments, the energy delivered by the laser pulses is sufficient to cause a lightening of the fabric color but is also carefully controlled to not over-expose or over-irradiate the fabric component, which may cause burning or charring of the fabric material. The power delivered during the laser irradiation operation 706 may also be carefully controlled to reduce or minimize warping of the material or other potentially undesirable effects caused by heating the material.

In some embodiments, operation 706 is used to lighten the area of the glyph to create a lightened or substantially white glyph within a dark or colored key region. For example, the laser may irradiate a region within the glyph to form a lightened glyph region surrounded by a colored region, sometimes referred to as a positive image of the glyph. In some embodiments, the colored region is black or grey and the lightened region of the glyph is substantially white. Alternatively, operation 706 may be used to lighten the region around the glyph to form a negative image of the glyph. For example, the laser may irradiation a portion of the key region exterior to the glyph to leave a dark or colored glyph surrounded by a lightened or substantially white background created by the laser, sometimes referred to as a negative image of the glyph.

In some embodiments, the resolution of the glyph may be determined by the spot size of the laser and also the size and density of the fibers or threads used to form the fabric. In some embodiments the fabric membrane of the keyboard is formed from a polyimide or nylon material having a fiber density ranging from 40 to 70 denier. In some embodiments, the fabric membrane of the keyboard is formed from a polyester material having a fiber density ranging from 40 to 70 denier.

With respect to process 700 of FIG. 7, additional operations may be performed to form the keys of the keyboard. In particular, in some embodiments, the embossed key region may be bonded to the top of a keycap associated with the key. In some embodiments, the embossed key region is bonded to the keycap using an adhesive to form a substantially flat and rigid surface. In some case, the keycap provides structural support and rigidity for the embossed key region. In some embodiments, the bonded keycap may be integrated or assembled within a keyboard frame and disposed above a switch to form the keyboard. In some embodiments, a non-embossed region or regions of the fabric membrane are bonded to a frame of the fabric keyboard An example fabric-based keyboard assembly is described above with respect to FIG. 4.

While process 700 of FIG. 7 is described with respect to laser marking an embossed fabric membrane, in other embodiments, the fabric membrane may not necessarily include embossed regions. For example, the fabric membrane may be a substantially flat sheet that is positioned above one or more key switches of a keyboard. Additionally, process 700 may be used to mark non-embossed regions or portions of a fabric membrane having embossed regions. For example, process 700 can be used to form text, graphics, or identifying symbols on portions of the fabric membrane that are not embossed keys.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

What is claimed is:

1. A method of laser-marking a fabric material, the method comprising:
providing a fabric component having a surface that is dyed a first color using a pigment;
irradiating the surface using a laser to form a lightened region, wherein the lightened region has a second color that is lighter than the first color.

2. The method of claim 1, wherein the lightened region has a reduced concentration of pigment due to the laser irradiation.

3. The method of claim 1, wherein irradiating the surface using the laser causes an increase in a surface concentration of TiO₂ with respect a non-irradiated region of the surface.

4. The method of claim 1, wherein the increase in surface concentration of TiO₂ is less than 100 nanometers from the surface of a fiber of the fabric component.

5. The method of claim 1, wherein the fabric component is formed from a nylon fabric material having a TiO₂ additive.

6. The method of claim 1, wherein irradiating the surface using the laser causes an increase in a surface concentration of CaCO₃ with respect a non-irradiated region of the surface.

7. The method of claim 1, wherein irradiating the surface using the laser causes evaporation of at least part of the pigment within an irradiated region.

8. The method of claim 1, wherein irradiating the surface using the laser causes evaporation of substantially all of the pigment within an irradiated region.

9. The method of claim 1, wherein irradiating the surface using the laser causes fibers of the fabric component to fuse to form a partially specular surface.

10. The method of claim 1, wherein irradiating the surface includes producing a series of pulses of ultraviolet light incident on the surface.

11. A fabric component comprising,
a colored region dyed a first color using a pigment; and
a lightened region formed by irradiating the colored region using a laser, wherein
the lightened region has a second color that is lighter than the first color due to the laser irradiation, and
the lightened region has a concentration of pigment that is reduced due to the laser irradiation.

12. The fabric of claim 11, wherein the lightened region includes fibers of the fabric component that are at least partially fused to form a partially specular surface due to the laser irradiation.

13. The fabric of claim 11, wherein the lightened region has an increased surface concentration of TiO₂ caused by the laser irradiation.

14. The fabric of claim 11, wherein the lightened region has an increased surface concentration of CaCO₃ caused by the laser irradiation.

15. The fabric of claim 11, wherein the lightened region is substantially white.

16. A method for forming a glyph on a key of a fabric keyboard, the method comprising:
providing a fabric membrane for forming an upper exterior surface of the fabric keyboard, wherein the fabric membrane includes an embossed key region having a dyed color;
positioning the embossed key region relative to a laser;
irradiating the embossed key region using the laser to form the glyph associated with the key of the keyboard, wherein an irradiated region formed by the laser has a color that is lighter than the dyed color of the embossed key region.

17. The method of claim 16, wherein forming the glyph using the laser includes increasing a surface concentration of TiO₂ for a laser-irradiated portion of the fabric membrane with respect to a non-irradiated portion of the fabric membrane.

18. The method of claim 16, wherein forming the glyph using the laser includes increasing a surface concentration of CaCO₃ for a laser-irradiated portion of the fabric membrane with respect to a non-irradiated portion of the fabric membrane.

19. The method of claim 16, wherein the dyed color includes a pigment and wherein forming the glyph using the laser includes reducing a concentration of pigment for a laser-irradiated portion of the fabric membrane with respect to a non-irradiated portion of the fabric membrane.

20. The method of claim 16, wherein forming the glyph using the laser includes at least partially fusing the fibers of the fabric membrane to create a partially specular surface.

21. The method of claim 16, further comprising:
bonding a lower surface of the embossed key region to a keycap of the fabric keyboard; and
bonding a non-embossed region to a frame of the fabric keyboard.

22. The method of claim 16, wherein the laser irradiates a region associated with the glyph to form a lightened glyph surrounded by a colored region.

23. The method of claim 22, wherein the colored region is grey and the lightened glyph is substantially white.

24. The method of claim 16, wherein the laser irradiates a region surrounding the glyph to form a lightened region surrounding by a colored glyph.

25. The method of claim 16, wherein the fabric membrane is formed from a nylon material having a titanium oxide additive.

26. A fabric keyboard comprising:
a set of keycaps configured to actuate a corresponding set of key switches;
a fabric component disposed over the set of keycaps, wherein the fabric component includes a colored region and at least one glyph that has been formed in the colored region using laser irradiation process, and wherein laser irradiation process lightens at least a portion of the colored region.

27. The fabric keyboard of claim 26, wherein the glyph has an increased surface concentration of TiO₂ created by the laser irradiation process.

28. The fabric keyboard of claim 26, wherein the glyph includes at least partially fused fibers formed by the laser irradiation process.

29. The fabric keyboard of claim 26, wherein the fabric component includes a pigment in the colored region and wherein the glyph includes a substantially reduced concentration of pigment due to the laser irradiation.
